(19) United States
(12) Patent Application Publication
(10) Pub. No.: US 2012/0046071 A1
(43) Pub. Date: Feb. 23, 2012

(54) SMARTPHONE-BASED USER INTERFACES, SUCH AS FOR BROWSING PRINT MEDIA

(76) Inventors: Robert Craig Brandis, Portland, OR (US); Tony F. Rodriguez, Portland, OR (US)

(21) Appl. No.: 13/079,327

(22) Filed: Apr. 4, 2011

Related U.S. Application Data
(60) Provisional application No. 61/375,789, filed on Aug. 20, 2010.

(51) Int. Cl. G06F 3/033

(52) U.S. Cl. 455/556.1

(57) ABSTRACT

Certain aspects of the present technology concern counterparts to smartphone gestural user interface operations that can be used with printed documents and other tangible objects. Other aspects involve mapping mouse-based user interface techniques for use with camera-equipped smartphones. A great variety of other features and arrangements are also detailed.

### RELATED APPLICATION DATA

This application is a non-provisional of application 61/375,789, filed Aug. 20, 2010, which is incorporated herein by reference.

In application Ser. No. 12/797,503, filed Jun. 9, 2010, and Ser. No. 12/855,996, filed Aug. 10, 2010, the assignee detailed a variety of technologies useful with smartphones and related systems, to help advance such devices into the realm of intuitive computing. The present technology concerns further improvements to the assignee's previous work, especially in the area of user interfaces.

The principles and teachings from these just-cited documents are intended to be applied in the context of the presently-detailed arrangements, and vice versa.

### INTRODUCTION OF THE TECHNOLOGY

A variety of easy-to-use interface techniques have been devised for computer devices, and are now in widespread use.

One familiar interface involves interaction with web pages and other documents that incorporate hyperlinks (aka “links”).

In one particular scenario, when such a page is presented on a computer screen, hyperlinks are commonly shown in text of a different color (e.g., blue) and may be underlined. A user can move a mouse (or other pointing device) to position a mouse-controlled arrow cursor on, or near, the link. As the cursor approaches the underlined text, the arrow commonly switches to a hand cursor. This indicates to the user that the cursor is within an active zone. The user can then issue a “click” command with the mouse, activating the link and causing new information to be presented on the screen.

Such an arrangement is shown by the web page excerpt of FIG. 1. The normal arrow cursor has changed to a hand cursor, and an underline has appeared under the blue hyperlinked text “DRMC.” Also shown by the dashed box in FIG. 1 is the “rollover zone” (sometimes termed the “hot area”) 102 that is associated with the link. When the arrow cursor enters this area, the cursor changes form, and a user click activates the link. (The extent of the rollover zone is not revealed to the user expressly; rather it is discovered by the user through use.)

Occasionally, when the cursor enters the rollover zone, a “tool tip” will appear on the screen. This is an annotation that is commonly used to provide the user further information about the link before it is activated.

Menus in application programs often work similarly. A user moves a mouse to position the arrow cursor on a button or other control. Instead of the cursor changing to a hand, the button/control is commonly highlighted—indicating that a click will invoke that function. Often a “tool tip” will be presented—giving additional information about the control at which the cursor is positioned.

It will be recognized that such interactions involve three stages. In the first, the arrow cursor is distant from a hyperlink/control, and clicking does nothing (at least as respects the hyperlink/control). This may be regarded as an “idle” stage.

In the second stage, the arrow cursor is within a zone associated with the hyperlink/control. In this position, something happens—the cursor changes form, or the control changes its appearance—alerting the user that the cursor is in position to activate something. This may be regarded as a “hovering” stage. No action is invoked by hovering unless/until the user issues a “click” command.

When the user issues a “click” command, the hyperlink/control is activated and takes an action. This third stage may be regarded as the “activated” stage.

Many of the UI principles familiar from desktop computers have counterparts on smartphones. For example, a link in a hyperlinked page is typically denoted visually (e.g., by a different color, and/or by underlining) so as to indicate its extra functionality. To activate the link, the user simply taps on the screen in a region on, or close to, the link. Likewise with a button or other control in a software program.

In the smartphone case, it will be recognized that there is no counterpart to the “hovering” stage. Until the user taps the screen, the presented page may be regarded as in an “idle” stage. When the issues a tap, it switches to an “activated” stage.

The user's “tap” operation on the smartphone screen is a form of gesture. Smartphones commonly support a variety of other gesture-based user commands. One is to sweep a finger down (or up) the screen—causing the displayed page of information to scroll down (or up). Another is to “pinch” with two fingers (placing the fingers on the screen, and moving them together). This causes the displayed page of information to be displayed at lower resolution—as by zooming-out. Conversely, the opposite operation, to “spread” with two fingers, causes the displayed page of information to be shown at greater resolution—as by zooming-in.

In one aspect, the present technology concerns counterparts to smartphone gestural user interface operations that can be used with printed documents and other tangible objects.

In another aspect, the present technology concerns mapping mouse-based user interface operations for use with camera-equipped smartphones.

The foregoing and additional features and advantages of the present technology will be more readily apparent from the following detailed description, which proceeds with reference to the accompanying drawings.

### BRIEF DESCRIPTION OF THE DRAWINGS

FIG. 1 shows an excerpt of a web page, showing a prior art interaction technique using a mouse and a desktop computer.

FIG. 2 shows a page of classified advertising, as imaged by a smartphone camera and displayed on a smartphone screen.

FIG. 3A shows a pointer cursor presented on a smartphone screen.

FIG. 3B shows a hand cursor presented on a smartphone screen, together with a “tool tip” display of associated information.

FIG. 4A shows two gestures, involving momentarily tipping the top of the phone down or up.

FIG. 4B shows two gestures, involving momentarily twisting the top of the phone towards the left or right.

FIG. 5 shows how a printed page may be virtually divided into blocks, indicated, e.g., by row and column numbers.

FIGS. 6A and 6B show other styles of cursors presented on a smartphone screen.

FIG. 7 shows a first form of cover flow-style user interface, by which augmented classified advertising may be reviewed on a smartphone.

FIG. 8 shows a second form of cover flow-style interface.

FIG. 9 shows a “Magic Lens” interface.

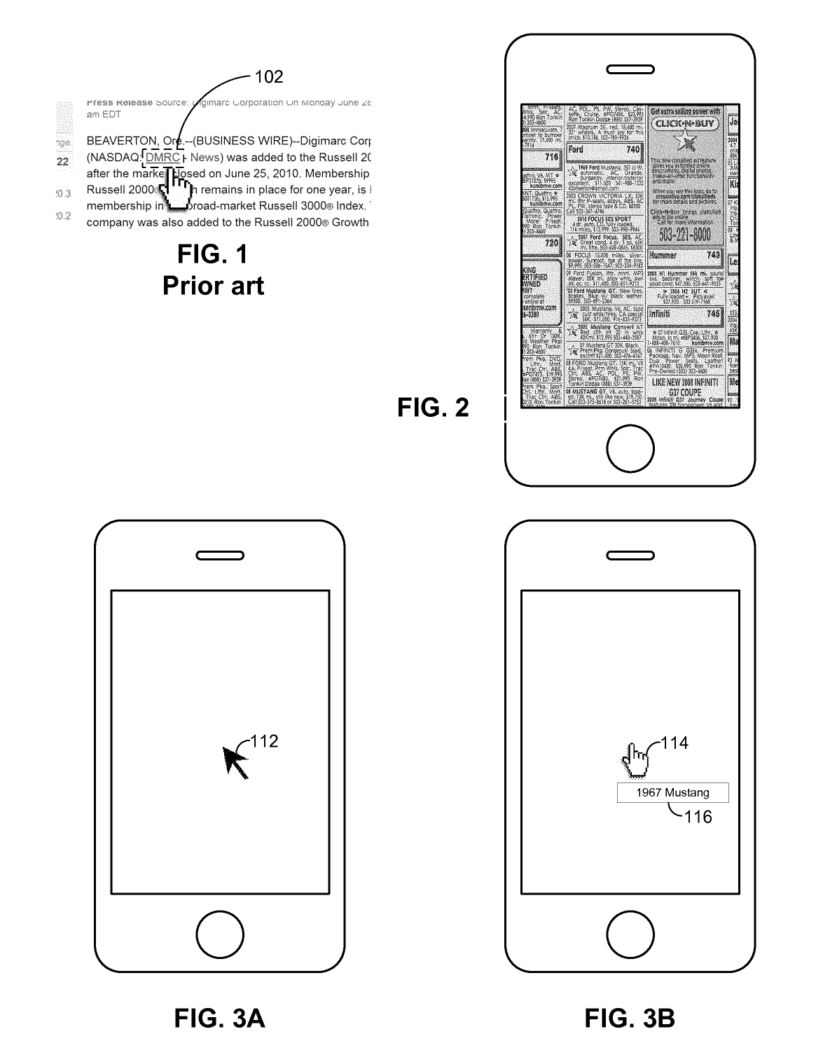

### DETAILED DESCRIPTION

The present technology is described in the context of digitally watermarked printed material, such as newspapers. However, the detailed principles are more generally applicable, e.g., requiring neither digital watermarks, nor printed material.

Digital watermark technology is used to embed auxiliary data into print, image or audio content. Exemplary watermarking arrangements are shown in the assignee's U.S. Pat. No. 6,590,996 and in published application 20100150434.

Commonly, digital watermarks are steganographic; that is, they escape attention. Often, watermarks are wholly imperceptible to humans, such as when pixels comprising an image are changed so subtly that the human eye literally cannot distinguish any difference. In other implementations, watermarking causes a change that is visible—but of such a character that a human viewer is not alerted that the marking conveys plural-bits of auxiliary data.

An example of the latter category of digital watermarking is background tinting. An inoffensive pattern of tiny dots, fine lines, or other features may extend across a piece of paper or other physical object—effectively giving the object an apparent tint. Such arrangement is particularly useful with newspapers and magazines. Different columns or other areas of text can be encoded with different backgrounds (conveying different watermark payload data), or an entire page can be encoded with the same payload. Examples are shown in the assignee's U.S. Pat. Nos. 6,985,600, 6,947,571 and 6,724,912, and in earlier-cited application Ser. No. 12/855,996.

FIG. 2 shows such an arrangement. Here, a smart phone camera is imaging a page of digitally watermarked classified advertising from a newspaper. (The paper is positioned about 6 inches from the camera.)

To access the functionality enabled by the watermark, the user activates a watermark reading mode of the smartphone. (This can be done in various ways known in the art, such as by a verbal instruction, a touch screen interaction, a physical button touch, etc.) In the watermark reading mode, a cursor arrow 112 appears over the imaged page of classified advertising, as shown in FIG. 3A. (The advertising imagery is not depicted in this and other figures, for clarity of illustration.)

Each enabled ad on the newspaper page has a rollover area associated with it. When the user moves the phone (or paper) so that the cursor arrow 112 is within the rollover area, the cursor changes form—to a hand cursor 114. A tool-tip 116 may also appear. This is shown in FIG. 3B.

The presentation of the hand cursor is familiar to the user, from experience with conventional computers. The user understands that this indicates the device is now ready to take an action (e.g., obtain additional information) upon receipt of a signal from the user. Rather than using a mouse, however, the user in this particular arrangement provides the activating input signal by a gesture.

A number of gestures can be sensed by a smartphone, using built-in sensors (e.g., accelerometers, gyroscopes, and magnetometers). Gestures can also be sensed by analyzing apparent motion of features within imagery captured by the phone's camera.

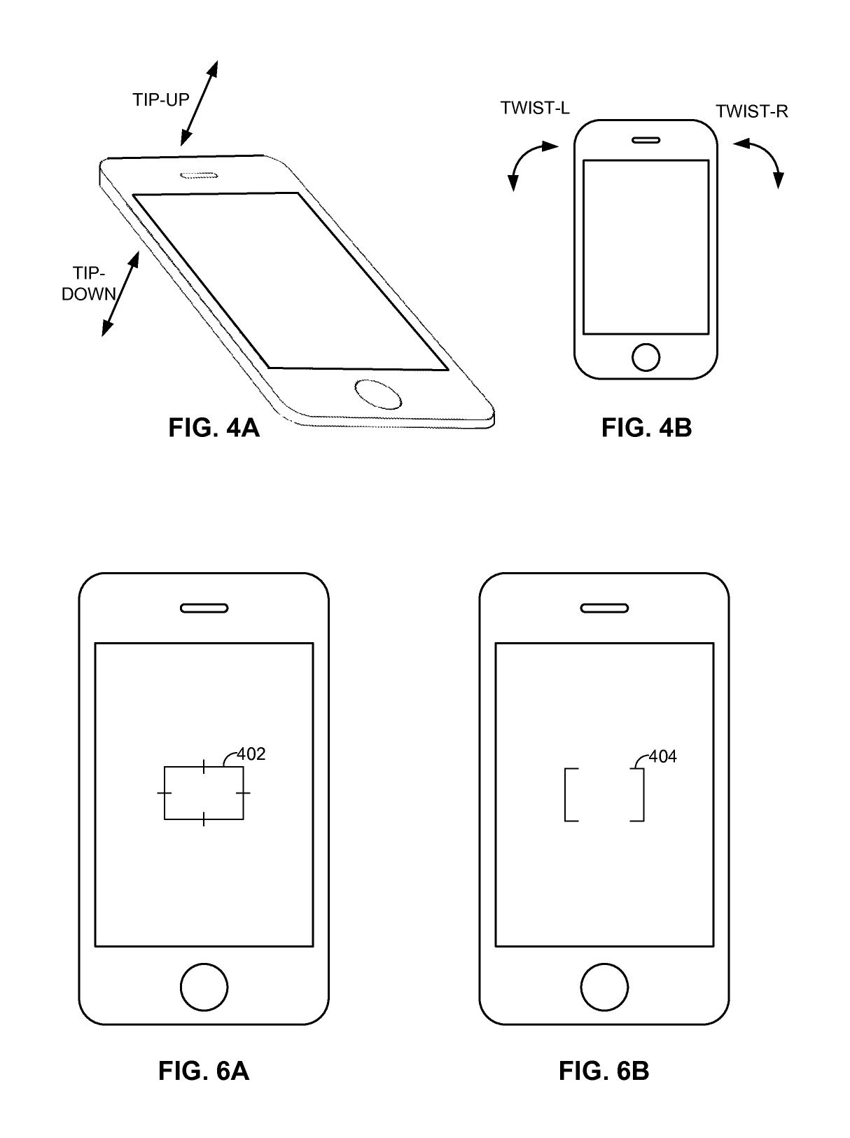

FIG. 4A shows two exemplary gestures: tipping the top of the phone briefly down and then up—termed “tip-down,” and the reciprocal “tip-up” gesture. FIG. 4B shows two more—momentarily cocking the phone to the left a bit (e.g., 10-30 degrees) and then returning to its former orientation, termed “twist-left,” and the complementary “twist-right” motion. A great number of other phone movements can also be used as gestures signaling user intent to phone software. (Earlier work by the assignee in gesture interfaces is shown in U.S. Pat. No. 7,174,031.)

In the exemplary embodiment, a tip-down gesture is used to signal that the user wants to pursue a link associated with the hand cursor. When this gesture is sensed, the phone presents a screen of detailed information about the selected advertisement—commonly with a richer presentation of information than is available from the print ad alone, e.g., including photos, links to videos, etc.

The foregoing discussion described a simple interaction from the user's viewpoint. The following discussion provides underlying technical details of this exemplary embodiment.

When the watermark reader is activated, the software monitors data output from the phone's camera system. The software wants to read a watermark—any watermark—to learn something about the user's activity.

In an illustrative embodiment, the watermark detector does not try to read a watermark unless imagery of a suitable quality is available. If suitable imagery is available, it is buffered and analyzed to determine whether a watermark appears present. If so, a watermark reading operation is performed.

Various assessments can be performed in this regard. One is to consider the phone's motion. If the phone is moving actively, the imagery is probably too blurry to be useful for watermark reading. Phone motion can be judged from sensor data (e.g., accelerometer, gyroscope). If the indicated motion exceeds a threshold, the captured imagery may be disregarded as of little use. In contrast, if the motion is below a threshold, the user is holding the phone steady enough that imagery suitable for watermark decoding may be captured.

Instead of inferring image blurriness/sharpness from other sensors, the pixel data itself can be examined. Sharp imagery (as contrasted with blurry imagery) tends to be characterized by relatively higher contrast, stronger edges, and higher frequency content. Image processing techniques familiar to artisans can be applied to pixel data in order characterize one or more of these parameters, and derive a metric indicating relative image quality. Again, only if the quality is above a threshold is watermark analysis performed.

Yet another technique for assessing image quality is to employ tools provided with the phone. The operating system of the Apple iPhone 4, for example, exposes various parameters that identify when the camera system's auto-focus portion has achieved focus-lock, when its auto-exposure portion has set a suitable exposure, and when its white balance portion has set a suitable white balance. In particular, the “CoreVideo” class of interfaces provided by the operating system expose such information, and can be invoked to pass such data to the watermark reader. Watermark detection/reading may be performed only if one or more of these (e.g., at least auto-focus lock) indicates suitable image quality.

When promising imagery is available, further testing may be applied before watermark reading is started. For example, the imagery may be checked for a dynamic range that is likely to allow watermark decoding. Similarly, the imagery can be checked for “flatness”—indicating a relative lack of features (as may occur if the camera is pointing to a blank wall), suggesting no watermark is present. (The assignee's U.S. Pat. No. 7,013,021 details useful screening strategies.)

When a frame of imagery is available that appears suitable, the software commences watermark analysis, e.g., using the techniques detailed in the assignee's U.S. Pat. No. 6,590,996 and published application 20100150434. (In some implementations, the frame may be a composite—formed using pixel data from two or more frames.)

The decoded watermark payload data may be of different types. In one arrangement it comprises a page ID, and a block ID. The page ID is a unique identifier that is associated with a particular newspaper page (e.g., page D5 of the Oregonian, metro edition, Aug. 20, 2010). The block ID indicates a particular region of the page.

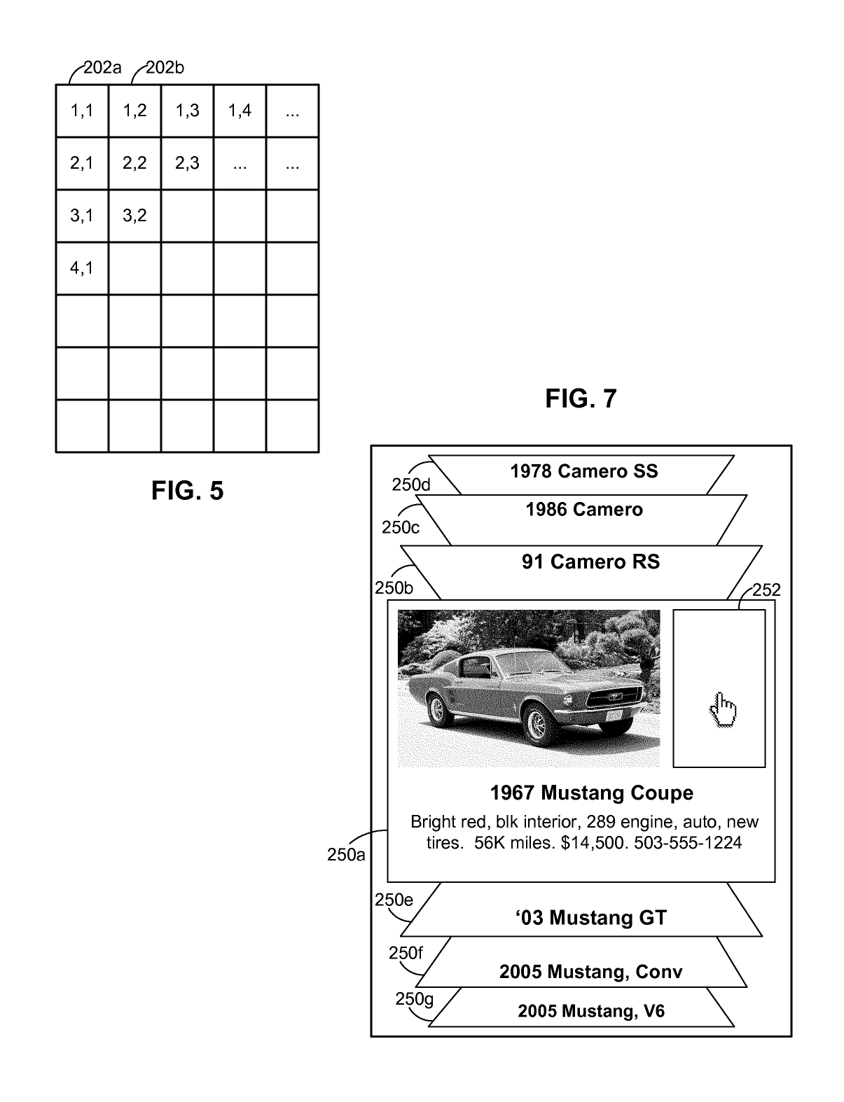

As shown in FIG. 5, a page can be regarded as composed of an array of square tiles 202a, 202b, etc. Each tile, or block, can be identified by a number. In the illustrated arrangement, each block is identified by two numbers—a row number and a column number.

Thus, a decoded watermark may have a payload including a page ID of 7B32A9, and a block ID of {1,4}. The former takes 24 bits to represent; the latter may take 8 bits. Larger or smaller watermark payloads can of course be used.

As soon as the watermark software has successfully read a watermark from captured imagery, it sends the decoded payload to a remote database system, and requests corresponding data in return. The database system includes information stored by the newspaper about watermarked pages and their contents (or includes pointers to other remote systems where such information is stored). From such remote repository, the smartphone requests information about the page and its contents.

The returned information indicates the user is looking at page D5 of the Aug. 20, 2010 Oregonian—and further indicates a particular tile region of the page. Assuming that network considerations permit, the returned information desirably also includes summary information about each advertisement on the page—together with links where additional information for each ad is stored. (Provision of such information in anticipation of later possible use speeds system response if the user later decides to view or use such information.)

To recap, in the exemplary embodiment, all of the above operations may occur as soon as a first sharp frame of imagery is available to the watermark decoder portion of the phone. No user action—other than activating the watermark reader—is required. (As detailed in earlier-cited application Ser. Nos. 12/797,503 and 12/855,996, user activation of watermark-reading functionality is not required in other embodiments. Instead, the phone may always be alert to possible digital watermarks in captured imagery.)

Once the phone has received information about the newspaper page from the remote system, consideration can then be given to the position of the cursor 112 on the page. As detailed in the earlier-referenced patent documents, the detailed digital watermark includes embedded registration data allowing the watermark software to discern a 6D pose of the watermarked object (i.e., the newspaper page).

More particularly, the watermark detector can sense the rotation of the captured imagery from its originally-encoded orientation, the scale of the watermark from its original size (related to viewing distance), and the translation of the sensed watermark pattern from the watermark's origin (further noted below). The viewing angle (expressed as offset from perpendicular) can also be estimated.

In the detailed arrangement, each block 202 is tinted with a unique watermark pattern tile that conveys the page ID, and a block ID for that block. (Although each block has a slightly different payload, they all appear unobtrusively uniform to a human observer.) As detailed in the cited documents, an illustrative watermark pattern tile is formed of 128×128 square sub-regions (termed watermark elements, or “waxels”). These sub-regions are located vertically and horizontally at a spacing of 66 to the inch. (In magazines, higher waxel density, such as 150 to the inch, may be used.) Thus, in this particular embodiment, a block 202 is 1.94 inches on each side. Each watermark tile has an origin at the upper left corner. (The watermark origin is the reference point from which the translation part of pose is related, as waxel offset in X- and Y-.)

The block 202a, in the upper left corner, has its top edge at the top of the page, and its left edge at the left page margin (assuming the watermark tinting goes to the edges of the page). Block 202a, next to it, again has its top edge at the top of the page, but its left edge 1.94″ from the left margin.

The upper left corner (origin) of each block 202 can similarly be determined from its block ID, which indicates row and column position. For example, block {3,2} has its upper left corner 3.88″ down from the top of the page, and 1.94″ from the left margin of the page. Thus, from the block ID, together with the pose data discerned from the watermark, the position of the arrow cursor 112 in FIG. 3A, within the printed page, can be resolved to 1/66^{th} of an inch, both vertically and horizontally. (The depicted cursor is at the center of the smartphone screen, although this is not necessary.)

The information returned from the remote database can be organized in terms of the X- and Y-position of each advertisement on the page (in inches, waxels, or otherwise). For example, the returned information can include coordinates for a rollover zone for each advertisement.

If the cursor arrow is found to have its tip within a rollover zone (or if the paper or camera is moved so as move the tip within such a zone), the software responds by changing the cursor to the hand form shown in FIG. 3B. The information returned from the remote database, associated with this rollover zone, can include a tool tip 116 (e.g., “1967 Mustang”) indicating the subject or other information associated with this part of the page.

The information returned from the remote database can also include the text of the printed advertisement, and typically includes other expanded information as well. If the operating system reports receipt of a user gesture (e.g., a “tip down” gesture), all such expanded information can be presented to the user.

(The attentive reader will note that the “top down” gesture deflects the camera aim from its original position, and results in the capture of blurred imagery—assuming frames are captured in free-running fashion. To facilitate use of phone-moving gestures in connection with camera imagery, the phone desirably has a first-in, first-out memory buffer where it stores recent frames of imagery—of a quality suitable for watermark detection. When a gesture is sensed that implicates camera imagery, this buffer is consulted to retrieve a frame of imagery that was stored before the gesture-associated movement began (typically the last-stored). The gesture-indicated operation is then performed by reference to this recalled frame of imagery.)

In one particular embodiment, when a hand cursor is displayed on the screen, and a tip-down gesture is sensed, the earlier-retrieved expanded information is presented on top of the camera imagery. (The imagery may be dimmed or made transparent, and/or the expanded information may be presented in a box that supplants the camera imagery in its area.) Alternatively, the camera imagery may be removed from the screen, and the expanded information may be presented alone.

In some implementations, the information returned from the remote database does not include all the expanded information for each advertisement on the page, but includes only links to such information. In this case, when the arrow cursor changes to a hand cursor, the smartphone can automatically use the link associated with that rollover zone to retrieve the expanded information (from wherever it is stored)—without waiting for a user gesture that triggers display of such information. The hand cursor, alone, is enough expression of user interest to warrant retrieval of the associated information.

As just noted, display of the hand cursor indicates at least a low level of user interest in that part of the printed page. (If the user then gestures, this expresses a still higher level of interest.) Such information is useful to various parties, e.g., the newspaper publisher, advertisers, third party consumer demographic repositories such as Nielsen, etc. Accordingly, certain embodiments of the present technology store information (a data log) indicating the printed content over which the user's smartphone at least momentarily rendered a hand cursor. Such action indicates likely user hovering over such point (e.g., to review a displayed tool tip). This logged information (which can also include other information, such as how long the user hovered over such ad, and whether the ad was pursued further, as by gestural invocation) may be provided to interested parties, e.g., in exchange for payment to the user, or in accordance with terms of service of the software. Those parties, in turn, can take action based on such “audience measurement” information, e.g., generating and providing reports to interested parties, setting different prices for advertising at different locations in the newspaper, etc. (E.g., if data shows that the upper outer corner of the newspaper pages are those most commonly noted by users, then advertisements placed at such locations may warrant higher insertions rates.)

FIG. 7 shows a “cover-flow” presentation of classified advertising information on a screen of a smartphone, in accordance with another aspect of the present technology. In such embodiment, expanded information for one advertisement is presented prominently on a virtual pane 250a displayed near the center of the screen. Above and below (or to the right and left, depending on implementation) are partial views of other panes 250b-250g. For these panes, less information is presented—such as just a title.

As the user moves the smartphone camera, panning up or down a column of advertising, the panes of the cover-flow interface flip in animated fashion, revealing details about adjoining advertisements. If the expanded information for the full page of advertising has been received from the database, then such panning yields a fluid, rippling display—akin to a magician artfully manipulating a deck of cards. But in this case the cards serve as lenses revealing further information about topics of interest to the user, all based on print media.

Again, still more information may be available. The pane 250a shown in FIG. 7, for example, includes a single picture, and limited text. While this pane is displayed, the user may make a tip-down motion with the phone, triggering presentation of still additional information—such as a gallery of other pictures, video, detailed specifications, etc. Again, such information may have been earlier downloaded from a remote store, and cached for ready delivery when so-requested by the user.

Other gestures may trigger other actions. For example, a tip-up gesture may cause the expanded information to be added to a memory for later review; a twist-left gesture may cause the expanded information to be emailed to a default destination, or posted to a social networking page associated with the user, etc.

The cover-flow interface of FIG. 7, like some others, faces a screen real estate issue. The viewer typically is less interested in the imagery captured by the smartphone, than in the expanded information to which such imagery enables access. Yet the imagery is a useful aid to navigation of the print media. As a compromise, the cover-flow interface can optionally include a virtual window 252 that allows the user to see an excerpt of imagery captured by the camera, as if visible from behind the cover flow. (Such imagery is omitted from FIG. 7 for clarity of illustration.)

The depicted window 252 is not at the center of the display screen. Yet it is the center of the display screen where the user commonly expects to find the cursor that points to items of interest. In the depicted arrangement the window 252 presents a rectangular excerpt of imagery taken from the center of the camera's field of view. A cursor icon can be presented in the middle of this window, pointing at imagery at the center of the camera's field of view. By such arrangement, the user retains the spatial context provided by a cursor overlaid on the printed imagery towards which the camera is directed, while still providing the other benefits of the cover-flow interface. (This rectangular window 252 may be stationary and persistent through the flipping animation of the different panes, as the camera is moved up or down the page.)

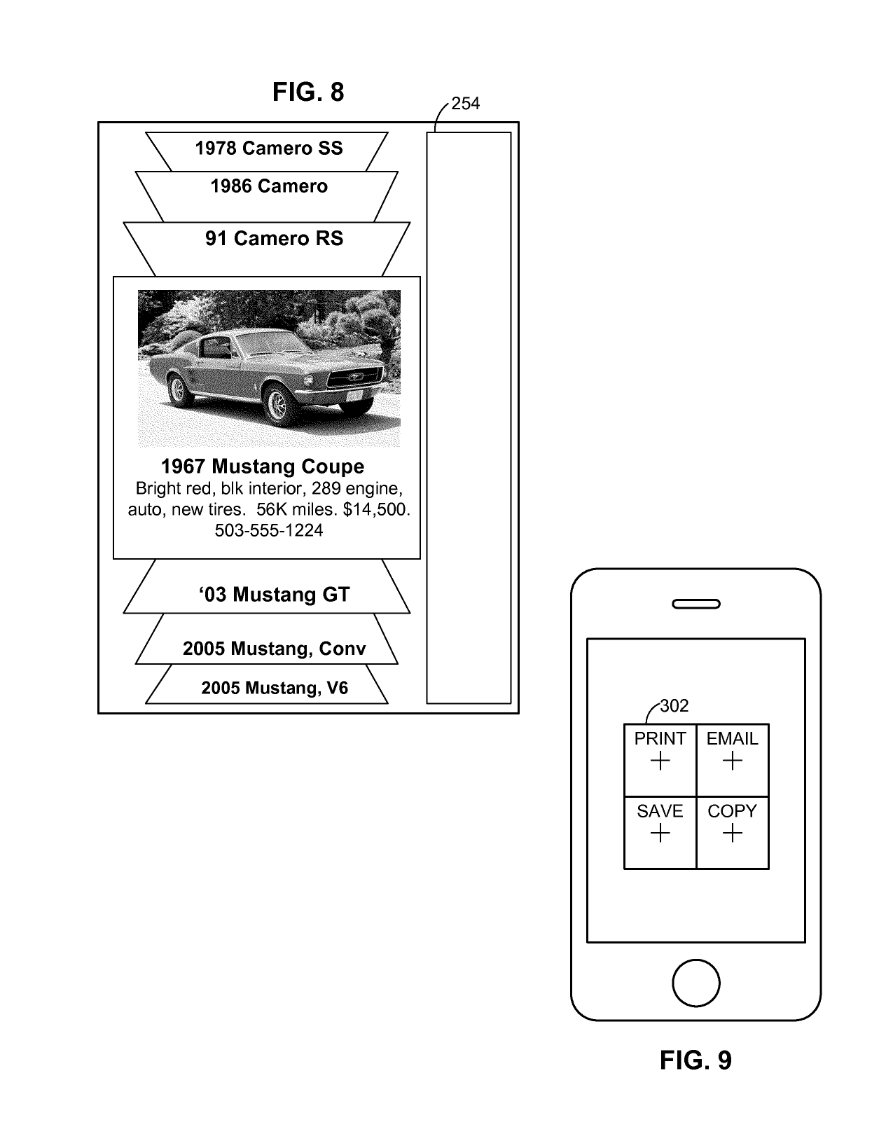

FIG. 8 shows a second cover-flow interface. In this embodiment, a window 254 is again provided for the display of captured imagery. In this case, however, the window extends essentially the full height of the display—allowing for a taller presentation of newspaper imagery. (Again, the presented imagery is taken from the center of the camera's field of view.) This particular implementation does not present a cursor within the window 254.

The embodiment of FIG. 8 is well suited for use with static, rather than live, camera imagery. The software can store a static image captured from the printed page, allowing the user to thereafter navigate by reference to this stored image. Such navigation can be done much later. For example, the user may capture imagery from a newspaper while standing in line in a coffee shop, and hours later—during lunch—explore based on the earlier-captured imagery.

In particular, the user can navigate by tapping the displayed imagery in window 254 at a desired point, or by sweeping a finger up or down the window. This latter action causes the cover-flow animation to activate, successfully flipping different panes into view.

Although the window 254 is of limited width, the user can also sweep a finger sideways across the window. This causes the underlying imagery to move with the finger (as is familiar from the Apple iPhone and the like)—revealing new parts of the captured imagery. For example, by sweeping a finger to the left, this causes new imagery to enter the window from the right, e.g., exposing a new column of advertising that the user can then browse. Such imagery can also be manipulated with “pinch” and “spread” gestures—causing the imagery to be presented at greater resolution (i.e., focusing on a smaller area) or lesser resolution (i.e., allowing a larger area to be seen). Again, such resized or repositioned imagery can be used as the basis for user browsing, using the cover flow paradigm.

In still other implementations of the cover-flow interface, the imagery from the camera may be displayed full-screen, but dimmed, or with reduced contrast. The depicted cover-flow arrangement may then be superimposed on this background—with a degree of transparency providing a sense of visual context with the underlying camera imagery.

It will be recognized that on-going interaction with captured imagery from the printed object is not required. Once a first watermark has been decoded from any point on a newspaper page, the smartphone can retrieve expanded information for all content on the page (indeed, for all content in the newspaper). The paper itself is not, strictly speaking, thereafter needed.

For example, the interface of FIG. 8 may omit the window 254. To browse ads on the imaged page of the paper, the user can simply make a sweeping scroll-up or scroll-down gesture with a finger on the screen. The expanded information corresponding to the advertising, downloaded from the remote computer, can be recalled from the memory, in order of their spatial positions, and presented in animated fashion using the cover-flow interface. The user can switch to an adjoining column of advertising by a sweeping finger motion to the left or right on the screen.

Moreover, the information presented on the display needn't be ordered in accordance with the spatial positions of the corresponding advertisements on the printed page. The information can be sorted by any other metadata, such as price, distance to the seller (e.g., estimated by telephone exchange or zip code), automobile model year, automobile color, etc. Such options can be defined by auxiliary menus, which may be invoked using conventional UI techniques.

In interfaces that make use of imagery corresponding to the printed page (e.g., FIGS. 7 and 8), it will be recognized that such imagery needn't all be captured by the smartphone. Once a first image of the page has been captured by the smartphone, the watermark reveals particulars about the publication and page number. Pristine imagery for the entire page (or for the entire publication) can be downloaded from the remote database, and thereafter be used instead of the (typically lower quality) imagery captured by the smartphone camera.

Again, a log detailing all of the information presented on the smartphone screen, and the duration of each such impression, can be collected and provided to third party users, such as Nielsen, if desired.

Smartphone cameras enable still other functionality. Consider, in particular, use of touch screen gestures.

Touchscreen gestures are useful UI constructs, but are best suited for non-portable devices. When used with a portable device, such as a smartphone, one hand typically holds the phone, and the other hand performs the touchscreen gesture. But it is not always convenient to devote both hands to smartphone operation.

In accordance with other aspects of the present technology, this two-hand modality can be avoided. Instead of gesturing with a finger (or fingers) on a touch screen, a corresponding command is issued by moving the phone.

Consider the “spread” gesture, which causes the display to zoom-in on an image being displayed. As is conventional, two hands are required, one to hold the phone, and the other to execute the “spread” gesture.

Camera imagery can be employed to effect such operation single-handedly. The user simply moves the phone's camera towards whatever it is pointing to. Software in the phone performs feature tracking on imagery captured by the phone, and notes features moving towards the edge of the frame as the camera is physically moved towards an object. The object being imaged, and the camera data, need not be displayed on the screen. Instead, the stream of captured camera imagery is a proxy for finger gestures on the touch screen. By noting that the user is physically zooming the camera towards a subject, the software performs a corresponding zooming operation on whatever information is displayed on the smartphone screen—just as it did in the prior art in response to a spreading touch gesture.

Conversely with a pinching gesture. Movement of the camera away from a subject serves in lieu of the second hand performing the pinching gesture on the touch screen.

Rather than perform a feature tracking operation on the captured imagery, the smartphone may detect changing scale of a digital watermark included in a sequence of frames of captured imagery. If the scale increases, this indicates that the user is moving the phone towards a watermarked object—signaling an intended zoom-in operation on whatever information is being displayed on the screen. Conversely, if the scale decreases, this signals an intended zoom-out operation.

Although not yet enabled on the iPhone, the Apple Mac Book Pro has another touch screen gesture that rotates whatever information is displayed on the screen. This gesture involves placing two fingers on the screen, and then twisting the finger stance—while maintaining the inter-finger distance substantially constant.

In analog, a smartphone user can simply rotate the device, which serves to rotate the imagery captured in the camera's field of view. Such rotation can again be sensed from feature tracking in the captured imagery, or by reference to orientation information available from a 6D pose vector produced by the noted watermark detector.

The smartphone mode in which it interprets camera data as a proxy for touch-screen gestures can be launched by various known arrangements, such as spoken command, button press, whole phone gesture (e.g., FIGS. 4A/4B), or even a touch-screen gesture. It can be discontinued by similar means.

### Magic Lens

Magic Lens (aka “Toolglass”) is a user interface (UI) concept originally developed by researchers at Xerox PARC, that never became viable due to perceived impracticality. In accordance with aspects of the present technology, such UI is implemented in a highly practical form.

The Magic Lens arrangement is a two-handed UI. With one hand, the user operates a first pointing device (e.g., a mouse). This device moves a gridded palette of tools, commonly presented as a transparent overlay, on the user's desktop. One tool may be Copy. Another may be Paste. Another may be Email. Another may be Print. Etc.

The user manipulates the gridded tool overlay so that a desired tool (e.g., Print) is positioned over a particular object to which the tool is to be applied (e.g., a desktop icon representing a file).

Then, with the other hand, the user operates a second pointing device (e.g., a second mouse), which moves a cursor on the screen. The user positions this cursor to point at a particular tool within the displayed gridded array of tools. (Recall that the user earlier operated the first pointing device to position the tool grid with the Print tool overlying the desktop file icon.) Once the cursor has been positioned over the Print tool, the user clicks the second mouse. This causes the file represented by the icon to be printed.

This arrangement involves the spatial confluence of three objects: a feature on the user's original screen (e.g., desktop), in appropriate spatial alignment with a particular tool in the gridded palette, together with the mouse cursor.

Such arrangement is detailed in Xerox's U.S. Pat. No. 5,617,114, and in a number of journal publications. Two are by Xerox's Bier, et al, namely Toolglass and Magic Lenses: The See-Through Interface, Proc. of SIGGRAPH '93, 73-80 (attached to provisional application 61/375,789 as Appendix A) and A Taxonomy of See-Through Tools, SIGCHI '94 (attached to provisional application 61/375,789 as Appendix B).

The impracticality of this arrangement proved to be its two-handed operation. Such style of man-machine interaction was found to be ill-suited for most work environments.

In accordance with this aspect of the present technology, such impracticality is overcome by using the smartphone camera in a manner analogous to the first pointing device, and using the user's thumb (or other finger) in a manner analogous to the second pointing device.

FIG. 9 shows an example. In this mode of operation (which can be invoked by the user in conventional ways), associated software presents a gridded palette of tools as an overlay (optionally, transparent) on top of imagery captured by the smartphone camera. Each tile in the grid has a function associated therewith, identified by a label or other indicia. For example, tool tile 302 is labeled with the function PRINT. Each tile may also include some indicia by which the user can precisely aim the function to indicate with a particular point in the imagery, although such feature is not strictly necessary. In the illustrative embodiment a “+” (crosshair) is used.

The user positions the phone camera so that the desired function tile overlays a desired excerpt of imagery, e.g., a particular newspaper article or classified ad (not shown for clarity of illustration). The user then taps the desired function tile (e.g., PRINT) using a thumb, or other finger. This tap is sensed by the touchscreen interface provided by the smartphone operating system, and triggers execution of the selected function, applied to the object denoted by the “+”. In this case, the classified advertisement is printed on the default printer.

There are numerous variations on this theme. Indeed, essentially all of the operations, and constructs, detailed in the cited Xerox documents can be implemented by an artisan with a camera-equipped smartphone based on the foregoing description, without undue experimentation. These principles can likewise be applied to known two-handed UIs of other design—with camera position being one degree of control, and the user's tap at a desired location of the screen being another degree of control.

Other features and arrangements not contemplated in the Xerox documents, but taught herein and in the documents incorporated by reference, can similarly be applied using such arrangement, again without undue experimentation.

For example, the PRINT function just noted need not print just the text of the classified advertisement as published in the newspaper being imaged by the user. Instead, the expanded information obtained from a remote database—based on decoded watermark data, can be printed. In this case, the printed version of the advertisement is more detailed than the original.

Similarly, the camera imagery tapped by the user need not be “live.” Instead, after positioning the camera to overlay the tool palette at a desire position on the live imagery, the user can issue an instruction to capture a static frame (e.g., by a gesture, or spoken instruction). Once the frame is thereby frozen, the user can tap the desired tool tile to launch the desired operation—without worry that such manipulation might cause the tool palette to shift relative to the captured imagery.

A great number of other such variations are well within the skill of the artisan from the present disclosure.

### Concluding Remarks

From the foregoing, it will be recognized that the present technology extends concepts of user interfaces, and camera usage models, for smart phones. In one aspect, a graphical user interface for print media is provided. Moreover, such user interface leverages users' prior experiences interacting with online web pages, making such interaction intuitive—even without any instruction

It will be recognized that the detailed arrangements are exemplary only. Actual implementations are likely to differ in numerous details, such as with different iconography, different gesture vocabularies, additional actions and features, etc. Thus, the described arrangements should not be taken as bounding our technology, but rather as illustrating the inventive features in sample implementations, among myriad possible implementations.

Likewise, although described primarily in the context of classified advertising, it will be recognized that the same principles are also applicable in other contexts, including other print content, such as news articles, photographs, display advertising, etc.

Consider, for example, a news article. A newspaper may highlight a word or phrase within an article, using a distinctive typeface or other presentation, to indicate to the reader that expanded content is available. Such a graphical clue is familiar to users because of widespread use of such clues on web pages to denote hyperlinks. Indeed, the presentation adopted by the newspaper can mimic web page hyperlinks, such as by printing such words in blue color, and/or underlined. (Bolding may also be used.)

As before, as soon as the user captures a single suitable image frame from anywhere on the page, the publication and the page can be identified. Expanded content for the page can be downloaded to the smartphone, and cached for ready user access. Again, the downloaded information includes data defining the extent of the rollover zone associated with each item on the page. The size of the rollover zone can be smaller or larger, depending on whether the number of separately linked words/phrases is greater or smaller. If an article has just a single linked phrase (e.g., the lead-in sentence), the rollover box can be defined to encompass the entirety of that article on the printed page. At the other extreme, each word in an article may have its own link to (potentially different) expanded content.

In other arrangements, the availability of linked content is not indicated by highlighted words or phrases. Instead, users may become accustomed to find that essentially all print media has associated linked content. Holding the phone relatively stationary over any print media may result in discovery of the background tint at that location, causing the cursor to switch to a hand, and signal that the linked content is ready for display at the user's instruction. A tool tip foreshadowing the information available from the linked data may be presented, to help the user decide whether to follow the link.

Likewise with photographs published in a newspaper. Consider a photograph of President Obama and family. Positioning the smartphone so that the cursor 112 is over one of the children's faces may cause a tool tip to appear, e.g., identifying the child by name. Gesturing with the phone can then summon expanded information, such as the Wikipedia page for that child. (Watermarking in photographic imagery may be by tinting, or the halftone elements comprising the picture may be subtly modified to convey the auxiliary data—putting more signal energy where it is relatively less visible, and putting less energy where it may be relatively more visible, as is familiar to artisans.)

The cover-flow interface is useful not just with classified advertising, but also with newspaper articles. Again, by capturing a single image of any part of any newspaper page, the entire newspaper contents may be downloaded to the smartphone. The headline and lead paragraph (and optionally a photo) from each article may be presented on a cover flow pane. The user can review an electronic counterpart to the newspaper by sweeping a finger across the screen, flipping through successive panes/stories.

Again, the panes may be ordered in correspondence with their order in the printed newspaper, but this is not essential. Other orderings can be used. One ordering relies on user profile data, e.g., based on historical usage patterns. If the user historically spends more time reviewing stories involving local government and the Seattle Mariners, then such articles can be presented among the first panes shown. Conversely, if the user seems to have no interest in articles about reality shows, and obituaries, these materials can be put at the end of the cover-flow article order.

Sometimes the user may be rushed, and not able to explore all the expanded content made available by such technology. In one implementation, the phone stores expanded content for each item over which the user causes the cursor to hover (i.e., changing to a hand cursor). This information is kept in a virtual briefcase, or other data structure, in which it can be readily reviewed when the user has more leisure.

The artisan will recognize that this technology has natural social networking implications. One is that the user's history in reviewing expanded content may be posted to a social networking site, and shared with selected ones of the user's friends. Typically, such history is filtered before posting, based on profile settings or stored rules. An exemplary user may specify that the social networking page can identify (and link to) the three articles that the user spent the longest time reviewing within the past week, within the news section and/or opinion sections of the newspaper.

FIGS. 6A and 6B show other forms of cursors 402, 404 that can be employed with the present technology. In the prior art, such cursors have been presented in consistent, unchanging fashion, e.g., to indicate the zone of imagery on which the camera tries to focus. In accordance with aspects of the present technology, such cursors can serve to convey information about the camera system, or the captured imagery, to the user.

For example, progress in achieving focus—or a state of focus lock—can be signaled by changes to the cursor, such as by changing its size (e.g., becoming smaller as focused is gained). When focus lock is achieved, the cursor may change color.

Alternatively, the color of the cursor may be animated to signal progress in achieving focus, e.g., starting red, and progressing through a sequence of other conspicuous colors until it ends with black when focus is achieved. If focus is not achieved, the color can revert to its original red (or to another color).

Similarly, the cursor may flash at a rate dependent on a camera or image parameter. Or it may be animated (e.g., in a racing lights fashion) at a speed dependent on such a parameter.

Even the shape of the cursor may be modulated, e.g., with the straight lines taking a wavy or otherwise distorted form, with the amplitude and/or frequency of the distortion effect indicating a parameter of potential interest to the user.

Different of these effects can also be combined.

While focus was cited as an example of a parameter of potential interest to the user, others include auto exposure, white balance, degree of camera shake, the relative quality of the image for decoding a watermark, etc.

Another parameter of potential interest is viewing angle. Watermark detectors work best when looking straight down on the watermarked medium. If a watermarked page is viewed from an angle, the time required to decode the watermark increases.

The viewing angle can be estimated from the imagery—both from the watermark itself, and also from other visual clues (e.g., square boxes become distorted into trapezoids).

If the camera is looking straight-down onto the page, the cursors may be presented as shown in FIGS. 6A/6B. (Or, better still, in square- rather than rectangular-form.) If the camera is viewing the page from an angle, a corresponding side of the cursor can be presented in exaggerated size. The user will naturally tend to move the phone so that the cursor is presented in a symmetrical fashion, with its top and bottom sides all of equal dimension, indicating optimum viewing.

Alternatively, such viewing angle information can be conveyed by other modifications to the displayed cursors, including those reviewed above in connection with focus, etc.

The cited patent documents provide additional details that can be used to implement embodiments of the present technology. The described functionality can be implemented in software form by an artisan from the present disclosure, without undue experimentation. Details concerning the iPhone device, including its user interface, are provided in Apple's published application 20080174570.

To provide a comprehensive disclosure without unduly lengthening this specification, applicants incorporate-by-reference the patent applications and documents referenced above. (Such materials are incorporated in their entireties, even if cited above in connection with specific of their teachings.) These references disclose technologies and teachings that can be incorporated into the arrangements detailed herein, and into which the technologies and teachings detailed herein can be incorporated. The reader is presumed to be familiar with such prior work.

We claim:

1. A user interface method for browsing items on a printed page using a camera-equipped smartphone, the method including the acts:
displaying a cursor on a screen of the smartphone, in conjunction with imagery of the page captured by the camera;
by reference to steganographic information included in the captured imagery, determining a position of the displayed cursor within the printed page;
as the page is moved relative to the smartphone, sensing entry of the displayed cursor into a rollover zone associated with an item on the printed page; and
changing a form of the cursor when the cursor enters said rollover zone.

2. The method of claim 1 that further includes:
using a programmed processor in the smartphone to decode plural-symbol data from the steganographic information;
transmitting at least some of said data to a more system; and
as a consequence of the foregoing, receiving additional information at the smartphone.

3. The method of claim 2 in which the received additional information includes information defining said rollover zone.

4. The method of claim 1 that further includes:
after said changing a form of the cursor, logging information associated with the rollover zone, and providing such logged information to a data store remote from the smartphone, to enable study of user behavior.

5. The method of any of the foregoing claims that further includes:
after changing the form of the cursor, sensing a smartphone gesture; and
in response to said sensed gesture, taking an action associated with the rollover zone.

6. The method of claim 5 that further includes:
after sensing the smartphone gesture, logging information associated with the rollover zone, and providing such logged information to said data store, to enable further study of user behavior.

7. The method of claim 1 in which in which the steganographic information comprises digital watermark information.

8. The method of claim 1 in which in which the steganographic information comprises glyph information.

9. A method comprising:
presenting camera-captured imagery on a display of a smart phone;
overlaying plural indicia on said presented imagery, each indicia being associated with a different region of the display, each indicia corresponding to a function;
receiving a signal indicating a sensed user tap at a first region on the display; and
invoking a function associated with said first region, as indicated by first indicia associated with said first region, and applying said function to data corresponding to a portion of imagery over which said first indicia is overlaid.

10. The method of claim 9 in which said presented imagery was earlier captured, and stored in a buffer for static presentation on the display, to facilitate user interaction.
